(19) United States
(12) Patent Application Publication
(10) Pub. No.: US 2005/0287895 A1
(43) Pub. Date: Dec. 29, 2005

(54) Assemblies of split fibers

(76) Inventor: Vishal Bansal, Overland Park, KS (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/166,863

(22) Filed: Jun. 24, 2005

Related U.S. Application Data
(60) Provisional application No. 60/582,628, filed on Jun. 24, 2004.

(51) Int. Cl. D01F 8/00; D04H 5/00; D04H 13/00; D04H 3/16; B32B 5/26; D02G 3/00; D04H 3/00; D04H 1/00; B29C 47/06; D01D 5/30; B29C 63/00; B32B 31/00

(52) U.S. Cl. 442/361; 442/401; 442/382; 428/364; 264/171.1; 264/172.11; 264/173.12

(57) ABSTRACT

Assemblies of fibers formed by splitting fibers formed from distinct compatible polymeric components, wherein at least one of the compatible polymeric components includes a liquid crystalline polymer and another of the compatible polymeric components includes a thermoplastic isotropic polymer and despite being compatible, the liquid crystalline polymeric component readily separates from the thermoplastic isotropic polymeric component without requiring a separate mechanical or chemical treatment step to achieve splitting.

### BACKGROUND OF THE INVENTION

1. Field of the Invention

This invention relates to split fibers prepared by splitting multiple component fibers that include at least two distinct compatible polymeric components.

2. Description of the Related Art

Splittable fibers are made by co-spinning two or more distinct polymeric components into multiple component fibers such that the polymeric components form non-interlocking separable segments across the cross-section of the fibers that extend along the length of the fibers. Nonwoven fabrics comprising fine fibers formed by splitting larger multiple component fibers in a fibrous web are known in the art. The fiber segments in the multiple component fibers are separated using mechanical force such as high pressure water jets (e.g. in a hydraulic entangling process), beating, carding, or other mechanical working of the fibers. Splittable fibers have also been split in a heat treatment process or in a drawing process. The distinct polymeric components are selected to be incompatible so that the polymeric components readily separate during the splitting process.

International Publication Number WO 99/19131 to Haggard et al. describes a method for in-line fiber splitting in a spunbond process wherein splitting is achieved by differential heat shrinkage of two or more components of plural component fibers.

U.S. Pat. No. 5,783,503 to Gillespie et al. describes preparation of products from thermoplastic splittable continuous multicomponent fibers. The fibers are at least partially splittable into smaller fibers in the absence of mechanical treatment or application of high pressure water jets. Differences in crystallization behavior of the polymeric components can promote splitting.

U.S. Patent Application Publication No. 2003/0203695 to Polanco et al. describes splittable multicomponent fibers wherein at least one of the polymer components comprises between about 10-95 wt % filler. The polymers themselves may or may not be incompatible and a separate treatment, such as contact with a scraping blade, is used to impart mechanical force to split the multicomponent fibers.

U.S. Pat. No. 5,895,710 to Sasse et al. describes a process for in-line splitting of multiple component fibers that are formed from at least two incompatible components by drawing the fibers under hot aqueous conditions.

There remains a need for fine fiber nonwovens and other fine denier fibrous materials without resort to the use of incompatible polymers and/or treatments to induce splitting.

### BRIEF DESCRIPTION OF THE DRAWINGS

FIGS. 1 and 2 are schematic representations of transverse cross-sections through fibers having a side-by-side cross-section.

FIGS. 3 and 4 are schematic representations of transverse cross-sections through fibers having a sectional cross-section.

FIGS. 5 and 6 are schematic representations of transverse cross-sections through fibers having a segmented-pie cross-section.

FIG. 7 is a schematic representation of a transverse cross-section through a fiber having a chrysanthemum cross-section.

FIG. 8 is a schematic representation of a transverse cross-section through a fiber having a tipped trilobal cross-section.

FIG. 9 shows a side-elevation view of a conventional spunbond apparatus suitable for preparing a bicomponent spunbond web.

### DETAILED DESCRIPTION OF THE INVENTION

The present invention relates to an assembly of fibers comprising small effective diameter split fibers, wherein the split fibers are obtained by splitting multiple component fibers comprising at least two compatible distinct polymeric components. The splitting occurs between adjacent segments of the compatible polymeric components. In one embodiment, the assembly of fibers comprises a nonwoven web. For example, the assembly of fibers can comprise a spunbond nonwoven web comprising continuous split fibers prepared in a spunbond process wherein the multiple component fibers are split, without requiring heating or additional processing, prior to laydown of the spunbond web.

The term “copolymer” as used herein includes random, block, alternating, and graft copolymers prepared by polymerizing two or more comonomers and thus includes dipolymers, terpolymers, etc.

The term “liquid crystalline polymer” (LCP) is used herein to embrace polymers that exhibit crystalline properties while exhibiting fluidity when melted. LCP's are anisotropic when melted, i.e., they exhibit molecular orientation in the melt. Molecular orientation is measured by birefringence, which is characterized by a difference between the refractive index in a first direction and a second direction perpendicular to the first direction. Birefringence can be measured with a polarizing microscope using methods known in the art. Non-LCP's are isotropic in the melt. The term “thermoplastic isotropic polymer” is used herein to refer to thermoplastic polymers that are isotropic in the melt, as characterized by a lack of molecular orientation in the melt phase, that is, having a refractive index that is substantially independent of direction in the melt.

The term “polyester” as used herein is intended to embrace polymers wherein at least 85% of the recurring units are condensation products of dicarboxylic acids and dihydroxy alcohols with linkages created by formation of ester units.

The term “nonwoven fabric, sheet, layer, or web” as used herein means a structure of individual fibers, filaments, or threads that are positioned in a random manner to form a planar material without an identifiable pattern, as opposed to a knitted or woven fabric. Examples of nonwoven fabrics include meltblown webs, spunbond webs, carded webs, air-laid webs, wet-laid webs, and spunlaced webs and composite webs comprising more than one nonwoven layer.

The term “spunbond fibers” as used herein means fibers that are melt-spun by extruding molten thermoplastic polymer material as fibers from a plurality of fine, usually circular, capillaries of a spinneret with the diameter of the extruded fibers then being rapidly reduced by drawing and then quenching the fibers. Spunbond fibers are generally continuous fibers.

The term “meltblown fibers” as used herein, means fibers that are melt-spun by meltblowing, which comprises extruding a melt-processable polymer through a plurality of capillaries as molten streams into a high velocity gas (e.g. air) stream. Meltblown fibers generally have a diameter between about 0.5 and 10 micrometers and are generally discontinuous fibers but can also be continuous.

The term “spunbond-meltblown-spunbond nonwoven fabric” (SMS) as used herein refers to a multi-layer composite sheet comprising a layer of meltblown fibers sandwiched between and adhered to two spunbond layers. Additional spunbond and/or meltblown layers can be incorporated in the SMS fabric, for example spunbond-meltblown-meltblown-spunbond (SMMS), etc.

The term “multiple component fiber” as used herein refers to a fiber that is made from at least two distinct polymeric components that have been spun together to form a single fiber. The at least two polymeric components are arranged in distinct substantially constantly positioned zones or segments across the cross-section of the multiple component fibers, the zones extending substantially continuously along the length of the fibers. As used herein, multiple component fibers include splittable multiple component fibers that exist as intermediate fibers prior to splitting during the spinning process. Such splitting forms split fiber segments corresponding to the segments in the multiple component fiber formed by the distinct polymeric zones. Such splittable fibers are also referred to herein as “parent” fibers. The multiple component parent fiber can split substantially immediately upon exiting the spinneret orifice from which it is spun. A specific type of multiple component fiber is a bicomponent fiber that is made from two distinct polymeric components. Multiple component fibers are distinguished from fibers that are extruded from a single homogeneous or heterogeneous blend of polymeric materials. The term “multiple component nonwoven web” as used herein refers to a nonwoven web comprising multiple component fibers. The term “bicomponent nonwoven web” as used herein refers to a nonwoven web comprising bicomponent fibers. A multiple component web can comprise both multiple component and single component fibers. In order to form splittable fibers, the polymeric components are arranged in a non-occlusive configuration so that the distinct polymeric segments are readily separated during splitting. At least one dissociable segment comprising one of the distinct polymeric components forms a portion of the peripheral surface of the fiber and has a configuration that is not enveloped by adjacent segments and therefore is not physically impeded from being separated from an adjacent segment or segments. Splittable fiber cross-sections are known in the art.

The term “split fiber” as used herein refers to fibers obtained upon separation, or splitting of a multicomponent fiber into two or more fiber segments by separation between adjacent segments of distinct polymeric components of a multiple component fiber. Split fibers include fibers that have been partially split away from a multiple component parent fiber. The term split fiber also includes fibers that are spun in a process wherein the distinct polymeric components are contacted prior to extrusion from an orifice and separate spontaneously upon exiting the orifice.

The term “compatible polymers” is used herein to refer to polymers that form a miscible blend, i.e. the polymers are miscible when melt blended together.

Polymer solubility parameters may be used to select suitably compatible polymers for use in the present invention. The polymer solubility parameters of various polymers are well known in the art. For example, a discussion of the solubility parameter is disclosed in Polymer: Chemistry and Physics of Modern Materials, pages 142-145, by J. M. G. Cowie, International Textbook Co., Ltd., 1973, which is hereby incorporated by reference. Adjacently disposed compatible distinct polymeric components of the multiple component fibers desirably have a difference in the solubility parameter of less than about 3 (cal/cm³)^{1/2}. More preferably, adjacent polymeric components have a difference in the solubility parameter of less than about 2 (cal/cm³)^{1/2}. When one or more of the distinct polymeric components comprises a blend of two or more polymers, a volume-weighted average is used to calculate the solubility parameter. For example, if a polymeric component is a blend of 25 volume % Polymer A and 75 volume % Polymer B, the solubility parameter for the blend is calculated as 0.25(solubility parameter of Polymer A)+0.75(solubility parameter of Polymer B).

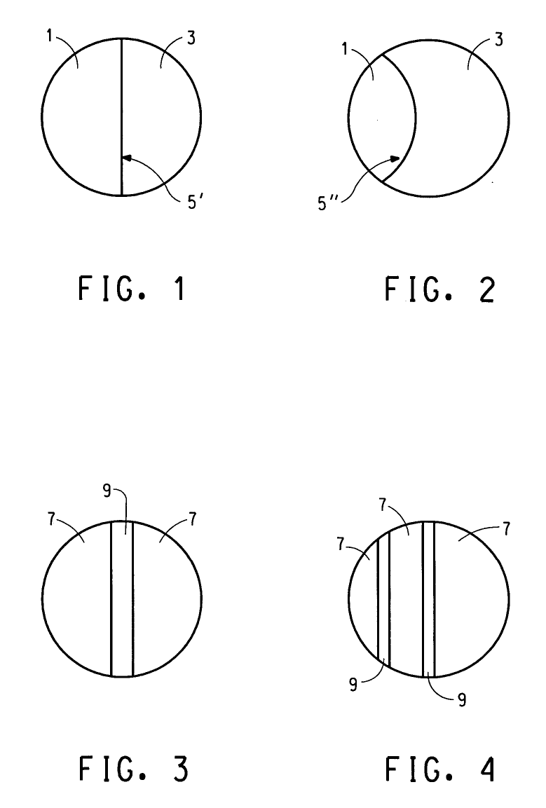

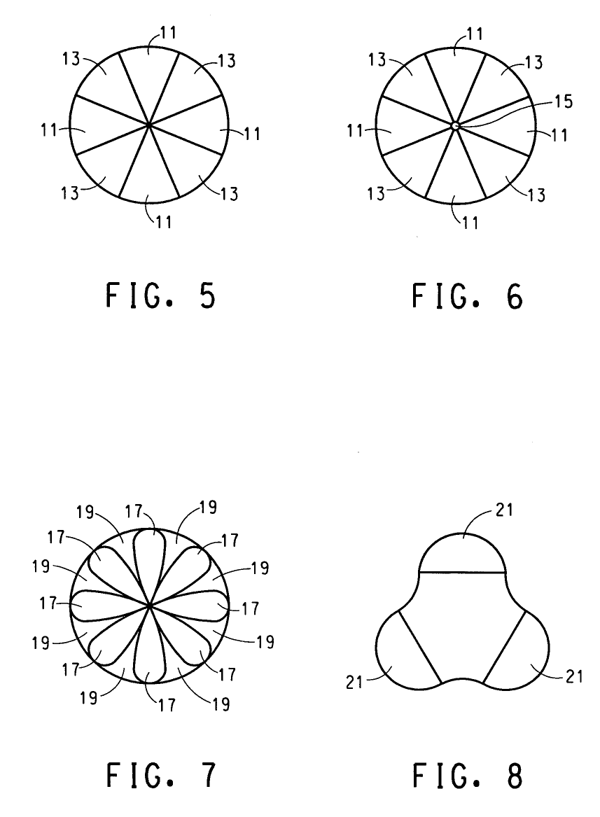

Suitable non-occlusive fiber cross-sections are shown in FIGS. 1-8. FIGS. 1 and 2 illustrate bicomponent side-by-side cross-sections wherein a segment 1 of the first polymeric component is adjacent segment 3 of the second polymeric component that is compatible with the first polymeric component. Each segment is substantially continuous along the length of the fiber with both polymeric components being exposed on the fiber surface. The interfaces 5′ and 5″ between the segments can be straight as in FIG. 1 or curved as in FIG. 2, respectively. FIGS. 3 and 4 illustrate sectional configurations wherein at least one polymeric component forms two or more segments 7 alternately arranged with one or more segments 9 of a second polymeric component, similar to a side-by-side arrangement. FIG. 5 illustrates a segmented pie fiber cross-section comprising alternating wedge-shaped segments 11 of the first polymeric component and 13 of the second polymeric component. FIG. 6 illustrates a hollow segmented-pie fiber cross-section similar to FIG. 5 except the parent fiber of FIG. 6 has a void 15 extending through the center of the fiber. FIG. 7 illustrates a cross-section sometimes referred to in the art as a chrysanthemum cross-section in which segments 17 of one of the polymeric components are petal-shaped and partially overlapped by adjacent segments 19 of a second polymeric component. While there is some partial occlusion of the petal-shaped segments due to the overlap with adjacent segments, the segments are able to readily separate to form split fibers. FIG. 8 illustrates a tipped trilobal cross-section wherein one of the distinct polymeric components forms segments 21 on the tips of the lobes. Other cross-sections suitable for forming splittable fibers are known in the art. The fiber cross-section can be symmetric or asymmetric. The fibers can have round cross-sections or other cross-sectional shapes such as elliptical or multi-lobal cross-sections. The distinct polymeric components can be present in equal amounts or in unequal amounts. The spinning conditions and equipment are preferably chosen such that the individual split fiber segments have an effective fiber diameter of less than 0.04-50 micrometers. For example, the split fiber segments can have an effective fiber diameter of no greater than about 10 micrometers, preferably in the range of about 1 micrometer to 10 micrometers. As used herein, the “effective diameter” of a fiber (e.g. split segment or combination of split segments obtained by at least partially splitting fibers according to the present invention) with an irregular cross section is equal to the diameter of a hypothetical round fiber having the same cross sectional area.

The materials of the present invention are preferably formed from splittable parent fibers that comprise a first polymeric component comprising a liquid crystalline polymer and a second polymeric component comprising a thermoplastic isotropic polymer. The first and second polymeric components are arranged in adjacent segments in a non-occlusive cross-section, such as the cross-sections described above. Suitable LCP's include liquid crystalline polyesters such as those described in U.S. Pat. No. 5,525,700, which is hereby incorporated by reference. The liquid crystalline polyester can be fully aromatic (based on an aromatic diol and an aromatic dicarboxylic acid) or can be partially aromatic (based on one or more aliphatic glycols containing 2 to 10 carbon atoms and an aromatic dicarboxylic acid). The second polymeric component in the parent fibers is selected such that it is compatible with the first polymeric component. When the first polymeric component comprises a liquid crystalline polyester, the second polymeric component can be selected from thermoplastic isotropic polyesters such as poly(ethylene terephthalate), poly(1,3-propylene terephthalate), poly(1,4-butylene terephthalate), poly(ethylene naphthalate), and poly (cyclohexylenedimethylene terephthalate), and copolymers or blends thereof. Other polyester copolymers can be used, including poly(ethylene terephthalate) copolymers in which between about 5 and 30 mole percent based on the diacid component is formed of isophthalate groups (e.g. derived from di-methyl isophthalic acid), and poly(ethylene terephthalate) copolymers in which between about 5 and 60 mole percent based on the glycol component is formed from 1,4-cyclohexanedimethanol. Poly(ethylene terephthalate) copolymers that have been modified with 1,4-cyclohexanedimethanol are available from Eastman Chemicals (Kingsport, Tenn.) as PETG copolymers.

Surprisingly, the compatible polymeric segments of the parent multiple component fibers are readily splittable. This is contrary to the prior art, which teaches use of incompatible polymer segments or compatible polymer segments that require high loadings of filler in at least one of the polymeric components to achieve significant splitting. Generally, the multiple component fibers at least partially split during the spinning process and are therefore not generally isolated as “unsplit” fibers. The split fiber materials of the present invention do not require a separate heat, mechanical, hydraulic or chemical treatment to induce splitting of the parent fiber. The parent fibers can split spontaneously during the multiple component spinning process.

In one embodiment, the assembly of fibers of the present invention comprises a multi-filament yarn or tow. In a preferred embodiment of the present invention, the assembly of fibers formed by splitting the multiple component fibers comprises a nonwoven fabric or web. The nonwoven web can comprise a spunbond nonwoven web comprising split substantially continuous spunbond fibers. Alternately, the nonwoven web can comprise a meltblown web comprising split meltblown fibers. The assembly of fibers may comprise secondary fibers including monocomponent and/or multiple component fibers, which can be continuous fibers or discontinuous fibers. The secondary fibers can be blended with the split continuous fibers or they can be deposited as a separate layer onto the web of split continuous fibers. Alternately, the assembly of fibers can consist essentially of the split continuous fibers.

In one embodiment, the assembly of fibers comprises a multi-layered nonwoven web wherein at least one of the layers comprises the assembly of split fibers. For example, the assembly of fibers can be a multi-layered web comprising at least one spunbond layer and at least one meltblown layer wherein the spunbond layer and/or the meltblown layer comprises the split fibers formed by splitting multiple component fibers comprising one or more LCP segments and one or more thermoplastic isotropic polymer segments. In one such embodiment, the assembly of fibers comprises a combination of meltblown and spunbond layers such as a SMS, SMMS, etc. nonwoven fabric in which at least one of the spunbond layers comprises an assembly of split continuous fibers of the present invention. In another such embodiment, the assembly of fibers is a SMS, SMMS, etc. nonwoven fabric in which the meltblown layer comprises split fibers prepared according to the present invention. Alternately, the spunbond and meltblown layers can each comprise split fibers of the present invention. One or all of the polymeric components may include non-polymeric additives known in the art including antioxidants, pigments, fillers, and the like. The additives are not required in order to achieve splitting of the components. Generally when pigments and/or particulate fillers are used, they are present at less than about 5 weight percent based on the polymeric component that comprises the additive and/or filler. The term “particulates” is used herein to refer to pigments and other solid fillers. For example, particulates can be added at a total of about 2 weight percent or less based on the polymeric component that comprises the particulates.

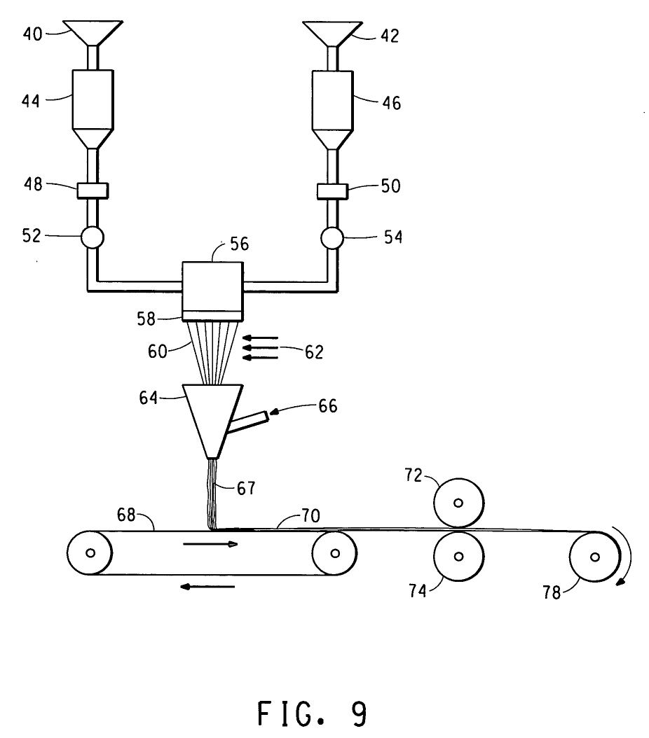

FIG. 9 shows a side-elevation view of a conventional spunbond apparatus for preparing a spunbond web from two distinct polymeric components. A liquid crystal polymer is fed to hopper 40 and a thermoplastic isotropic polymer is fed to hopper 42. The polymers in hoppers 40 and 42 are fed to extruders 44 and 46, respectively, which each melt and pressurize the polymer contained therein and force it through filters 48 and 50 and metering pumps 52 and 54, respectively. The two polymer streams are combined in spin block 56 by known methods to produce the desired non-occlusive fiber cross-section. The polymeric components can be chosen such that the thermoplastic isotropic polymer has a lower melting point than the LCP component to facilitate thermal bonding of the spunbond fabric. For example, the thermoplastic isotropic polymer can have a melting point that is at least 10° C. lower than the melting point of the LCP and more preferably has a melting point that is at least 20° C. lower than the melting point of the LCP. Alternately, the LCP can have the lower melting point. If thermal bonding methods are not used to bond the spunbond fabric, the polymeric components can have similar melting points. For example, if the nonwoven web is bonded by entanglement using high-pressure water jets (hydraulic entanglement), the difference in melting point is not important. The melted polymers exit spin block 56 through a plurality of capillary openings or orifices on the face of the spinneret 58 to form a curtain of fibers 60. The capillary openings may be arranged on the spinneret face in a conventional pattern, for example rectangular, staggered, or some other configuration. The fibers are cooled with quenching air 62 and then passed through a pneumatic draw jet 64 before being laid down to form a nonwoven web. The quenching air is provided by one or more conventional quench boxes (not shown) that direct air against the fibers, generally at a rate of about 0.3 to 2.5 m/sec and at a temperature in the range of 5° C. to 25° C. Alternately, a two-sided quench system can be used, wherein quench air is directed onto the curtain of fibers from both sides to achieve a more uniform quench. During the quenching step, the temperature of the fibers is sufficiently reduced so that the fibers do not stick to each other or to the inner walls of the jet while passing through the jet. Air 66 is fed to the draw jet and provides the draw tension on the fibers that causes the fibers to be drawn near the spinneret face. The air fed to the draw jet may be heated or unheated. The fibers 67 exiting the draw jet are deposited onto a laydown belt or forming screen 68 to form a web 70 of continuous fibers. Web 70 can optionally be passed between thermal bonding rolls 72 and 74 before being collected on roll 78.

Without wishing to be bound by theory, it is believed that the fibers at least partially split during the quenching step as the polymers solidify. Further splitting can occur as the fibers proceed from the quench zone through the pneumatic draw jet prior to laydown as a spunbond web.

### Test Methods

In the description above, the following test methods are employed to determine various reported characteristics and properties.

Effective Fiber Diameter is measured by optical microscopy and is reported as an average value in micrometers. For each sample comprising an assembly of split fibers according to the present invention, the diameters of about 100 fibers are measured and averaged.

Polymer melting point is determined using differential scanning calorimetry (DSC) according to ASTM D 3418-99.

1. An assembly of fibers comprising a plurality of first fiber segments of a first polymeric component comprising a first liquid crystalline polymer and a plurality of second fiber segments of a second polymeric component comprising a first thermoplastic isotropic polymer, wherein the first and second polymeric components are compatible and the first and second fiber segments are formed by at least partially splitting multiple component fibers comprising the first and second fiber segments arranged in distinct non-occlusive zones across the cross-section of the multiple component fibers and extending substantially continuously along the length of the multiple component fibers, wherein splitting occurs between the first and second fiber segments.

2. A nonwoven web, comprising the assembly of fibers of claim 1.

3. The nonwoven web of claim 2, wherein the first and second fiber segments comprise continuous fibers.

4. The nonwoven web of claim 3, wherein the nonwoven web is a spunbond web.

5. The nonwoven web of either of claims 2 or 4, wherein the first and second fiber segments have a non-round cross-sectional shape,

6. The nonwoven web of claim 5, wherein the first and second fiber segments are wedge-shaped.

7. The nonwoven web of claim 4 wherein the first and second fiber segments have an effective fiber diameter between about 0.04 micrometers and 50 micrometers.

8. The nonwoven web of claim 7, wherein the first and second fiber segments have an effective fiber diameter of no greater than about 10 micrometers.

9. The nonwoven web of claim 4, further comprising a layer of meltblown fibers adhered to a first side of the spunbond web.

10. The nonwoven web of claim 9, wherein the meltblown fibers are multiple component fibers.

11. The nonwoven web of claim 9, wherein the layer of meltblown fibers comprises a plurality of third and fourth fiber segments, wherein the third fiber segments comprise a second liquid crystalline polymer and the fourth fiber segments comprise a second thermoplastic isotropic polymer that is compatible with the second liquid crystalline polymer, the third and fourth fiber segments being formed by splitting multiple component meltblown fibers comprising the third and fourth fiber segments arranged in distinct non-occlusive zones across the cross-section of the multiple component meltblown fibers and extending substantially continuously along the length of the multiple component meltblown fibers, wherein the splitting occurs between the third and fourth fiber segments.

12. The nonwoven web of claim 2, wherein the first and second fiber segments comprise meltblown fiber segments.

13. The nonwoven web of any of claims 2 or 4, wherein the liquid crystalline polymer is selected from the group consisting of fully aromatic polyesters and partially aromatic polyesters and the thermoplastic isotropic polymer is a polyester selected from the group consisting of poly(ethylene terephthalate), poly(1,3-propylene terephthalate), poly(1,4-butylene terephthalate), poly(ethylene naphthalate), poly(cyclohexylenedimethylene terephthalate), polyester copolymers, and blends thereof.

14. The nonwoven web of claim 13, wherein the thermoplastic isotropic polymer is a polyester copolymer selected from the group consisting of poly(ethylene terephthalate) copolymers in which between about 5 and 30 mole percent based on the diacid component is formed of isophthalate groups, and poly(ethylene terephthalate) copolymers in which between about 5 and 60 mole percent based on the glycol component is formed from 1,4-cyclohexanedimethanol.

15. A spunbond nonwoven fabric, comprising a plurality of first continuous fiber segments of a first polymeric component comprising a liquid crystalline polymer and a plurality of second continuous fiber segments of a second polymeric component comprising a thermoplastic isotropic polymer, wherein the first and second fiber segments are formed by splitting a plurality of multiple component fibers comprising segments of the first and second polymeric components arranged in distinct non-occlusive zones across the cross-section of the multiple component fibers and extending substantially continuously along the length of the multiple component fibers, wherein the splitting occurs between the segments of the first and second polymeric components.

16. The spunbond fabric of claim 15, wherein the multiple component fibers have a cross-section selected from the group consisting of segmented pie and hollow segmented pie cross-sections.

17. A method for preparing a spunbond nonwoven fabric comprising split fibers, comprising the steps of:
(a) melt spinning a plurality of splittable continuous multiple component fibers from a spinneret, the multiple component fibers comprising a first polymeric component and a second polymeric component arranged in distinct non-occlusive zones across the cross-section of the multiple component fibers and extending substantially continuously along the length of the multiple component fibers, each of the first and second polymeric components comprising at least a portion of the peripheral surface of the multiple component fibers, wherein the first and second polymeric components are compatible and each of the first and second polymeric components comprises less than 5 weight percent of particulates;
(b) drawing the multiple component fibers after they exit the spinneret, while the first and second polymers are molten;
(c) quenching the multiple component fibers, wherein the multiple component fibers at least partially spontaneously split prior to the completion of the quenching step; and
(d) depositing the at least partially split fibers on a collecting surface to form a spunbond nonwoven web.

18. A method for preparing a spunbond fabric, comprising the steps of:
(a) melt spinning a plurality of splittable continuous multiple component fibers from a spinneret, the multiple component fibers comprising a first polymeric component comprising a liquid crystalline polymer and a second polymeric component comprising a thermoplastic isotropic polymer, the first and second polymeric components being arranged in distinct non-occlusive zones across the cross-section of the multiple component fibers and extending substantially continuously along the length of the multiple component fibers, each of the first and second polymeric components comprising at least a portion of the peripheral surface of the multiple component fibers, wherein the first and second polymeric components are compatible;
(b) drawing the multiple component fibers after they exit the spinneret, while the first and second polymers are still molten;
(c) quenching the multiple component fibers, wherein the multiple component fibers at least partially spontaneously split prior to the completion of the quenching step; and
(d) depositing the split fibers on a collecting surface to form a spunbond nonwoven web.
